(19) United States
(12) Patent Application Publication
(10) Pub. No.: US 2004/0239836 A1
(43) Pub. Date: Dec. 2, 2004

(54) Metal plated plastic component with transparent member

(76) Inventor: Lee A. Chase, East Grand Rapids, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 10/808,904

(22) Filed: Mar. 25, 2004

Related U.S. Application Data
(60) Provisional application No. 60/457,514, filed on Mar. 25, 2003.

(51) Int. Cl. G02F 1/1335; G02F 1/03; G02F 1/07

(52) U.S. Cl. 349/98

(57) ABSTRACT

An improved process for preparing assemblies comprising a metal plated plastic component having a transparent member, and the resulting assembly, are provided. The process includes molding a transparent plastic member of a non-plateable thermoplastic material; molding a plastic component around and/or on the transparent plastic member so that the transparent plastic member is physically trapped by the plastic component and/or chemically/electrostatically bonded to the plastic component, the plastic component being molded of a plateable thermoplastic material; and plating a metal onto the plastic component. The process involves fewer steps than known processes, results in less scrap and produces superior assemblies wherein the transparent member is more precisely in registry with the metal plated component.

### CROSS-REFERENCE TO RELATED APPLICATION

This application claims the benefit under 35 U.S.C. § 119(e) of U.S. Provisional Application No. 60/457,514 entitled LENS AND COVER, filed Mar. 25, 2003, by Lee A. Chase, the entire disclosure of which is incorporated herein by reference

### FIELD OF THE INVENTION

This invention relates to consumer products having a transparent member attached to a metal plated plastic component, and more particularly to metal plated plastic components having a transparent window or lens for viewing an underlying display or for propagating light from an underlying light source.

### BACKGROUND OF THE INVENTION

Known techniques of fabricating an assembly comprising a transparent member (such as a lens or transparent window), that is attached to a metal plated plastic component (such as a housing) have generally involved steps of separately molding the transparent member and plastic component, plating the plastic component, and attaching the transparent member to the metal plated plastic component with fasteners or adhesives. Assemblies of this type have been utilized, for example, in the housings of various electronic/electrical products (e.g., cell phones, cameras, video and/or audio players and/or recorders, etc.), in various lighting applications (particularly automotive lighting applications), and in vehicle instrument panels. Other potential applications include vehicle gear shift position indicator displays, and automotive chrome plated door handles having a lens that lights up, such as in darkness to facilitate better visibility of the handle.

A particular application of interest is the pivoted cover of a flip-style cell phone. Flip-style cell phones include a cell phone body enclosed by a pivoted cover. The flip cover includes a lens cover which has a bezel and lens through which a display screen can be viewed. The lens cover is typically molded from a layer of clear acrylic or clear polycarbonate over which a graphic film layer is applied. The film layer incorporates a clear section over the lens area and graphic elements over the bezel area. Additionally, the lens covers of the prior art may include a hard layer providing scratch resistance to the lens cover and UV protection for the display screen. The lens cover may include rib structures which can accommodate assembly or other components incorporated in the cover for the flip phone.

Typically, the lens cover is adhesively bonded to the flip cover and will be of a three-dimensional shape conforming to the outer surface of the flip cover. It includes a border extending around the periphery thereof conforming to the shape of a recess in the cover of the cell phone. The graphic film applied to the lens cover is extremely thin and difficult to handle. The surface of the lens cover must be relatively flat to avoid wrinkling the film when applied by in-molding to the lens cover. Further, the surface of the cover facing the film must be relatively smooth to avoid tearing the film upon application. The graphic film itself requires long lead times to develop printed images thereon for the bezel. Additionally, there is difficulty in registering the graphic film in precise alignment with the lens so that the resultant product appears as an integral structure with aligned components. As a result of these difficulties, there is significant waste in the manufacturing process, resulting in a significant amount of scrap parts increasing the cost of such lens covers and, ultimately, the cell phone itself.

There is a need for improved assemblies comprising a metal plated plastic component having a transparent member, and for improved processes for fabricating assemblies comprising a metal plated plastic component having a transparent member.

### SUMMARY OF THE INVENTION

In an aspect of the invention, there is provided a process for making an assembly including a plastic component having a transparent plastic member. The process includes steps of molding a transparent plastic member of a non-plateable thermoplastic material; molding a plastic component around the transparent plastic member so that the transparent plastic member is physically trapped by the plastic component, and/or chemically and/or electrostatically bonded to the plastic component, the plastic component being molded of a plateable thermoplastic material; and plating a metal onto the plastic component.

In another aspect of the invention, there is provided an assembly comprising a metal plated plastic component having a transparent member physically entrapped by the metal plated plastic component or chemically/electrostatically bonded to the plastic component.

These and other features, objects and advantages of the present invention will become apparent upon reading the following description thereof together with reference to the accompanying drawings.

### BRIEF DESCRIPTION OF THE DRAWINGS

FIG. 1 is a front elevational view of a flip phone of the present invention, shown with the cover closed;

FIG. 2 is a front elevational view of the flip phone shown in FIG. 1, shown with the cover in an open position;

FIG. 3 is a bottom view of the phone shown in FIG. 1;

FIG. 4 is an enlarged cross-sectional view of a lens cover of the prior art;

FIG. 5 is an enlarged plan view of the lens structure of the present invention;

FIG. 6 is a cross-sectional view taken through section line VI-VI of FIG. 5;

FIG. 7 is a plan view of a flip phone cover having a lens cover embodying one trim effect of the present invention;

FIG. 8 is a plan view of a flip phone cover having a lens cover embodying another trim effect of the present invention;

FIG. 9 is a plan view of a flip phone cover having a lens cover embodying another trim effect of the present invention;

FIG. 10 is a plan view of a flip phone cover having a lens cover embodying another trim effect of the present invention;

FIG. 11 is a plan of an integrated flip cover and lens;

FIG. 12 is a cross-sectional view of the flip cover, taken along section line XII-XII of FIG. 11; and

FIG. 13 is a perspective view of a magnifying lens in an alternative embodiment of the invention.

### DETAILED DESCRIPTION OF THE PREFERRED EMBODIMENT

The invention relates generally to a process for making an assembly that includes a transparent member that is physically entrapped by a metal plated plastic component, and the resulting assembly. An important aspect of the invention involves the use of a non-plateable thermoplastic material to mold the transparent plastic member, and the use of a plateable thermoplastic material to mold the plastic component that physically traps the transparent member. An advantage of the invention is that positioning of the transparent member with respect to the metal plated component can be precisely controlled during the molding process, eliminating problems and scrap associated with misalignment of the transparent member with respect to the metal plated component, as typically occurs with conventional processes utilizing adhesives and/or fasteners. The process also eliminates problems and scrap associated with scratching of the lens or metal plated component by fasteners and/or tools during mounting of the transparent member to the metal plated component, and/or misapplication of adhesives to the lens and/or exposed surfaces of the metal plated component during assembly. The process eliminates the need for fasteners and/or adhesives for attaching a transparent member to a metal plated component by utilizing a plateable material for molding the component, and using a non-plateable material for molding the transparent member, whereby it is possible to mold the plateable component so that it physically entraps the transparent member or becomes chemically/electrostatically bonded to the transparent member, and utilize immersion plating techniques for metal plating only the plateable component, without metal plating the transparent member.

As used herein, the expression “physically entrapped” refers to structural arrangement in which the “entrapped” transparent member is not removeable from the metal plated component without destroying at least one of the two components. This arrangement can be achieved by employing an insert-molding technique or a two-shot molding technique. In either case, the metal plateable component is not electroplated until after the transparent component has been either insert molded or otherwise entrapped by the plateable component.

The expression “chemically/electrostatically bonded” is intended to encompass various chemical interactions including covalent bonding, ionic bonding, Van der waal interactions, etc., as well as purely electrostatic interactions.

The transparent plastic member is a member that allows at least a substantial percentage of visible light of at least one frequency band to be propagated through the member. Thus, the expression “transparent” includes tinted or partially transparent materials. Suitable non-plateable thermoplastic materials that may be used for molding the transparent plastic member include various commercially available transparent polycarbonate resins and various commercially available transparent polymethylmethacrylate resins.

After the plateable plastic component has been molded on or around the transparent member to chemically/electrostatically bond and/or physically entrap the transparent member, the entire assembly may be subjected to conventional metal plating techniques. These techniques typically involve electrolessly depositing an electrically conductive (metal) coating on the surfaces of the plateable plastic component, electro-depositing on the electrically conductive coating at least one sublayer such as nickel, copper, brass, bronze or a combination of these, and electro-depositing over the sublayer(s) a decorative finish electroplate. Examples of preferred decorative finish electroplates include: chrome, brass, bronze, black nickel, black chrome, gold, silver and tin. Suitable electroless plating and electroplating techniques are well known in the art and therefore will not be described in detail. The thermoplastic material used to mold the transparent member (e.g., polycarbonate, polymethylmethacrylate) is selected to be relatively resistant to electroless deposition of metal. As a result, the transparent member is not coated with any substantial amount of metal and remains transparent after the electroplating process has been completed. Preferred metal plateable thermoplastic materials that may be utilized for molding the plateable component include acrylonitrile-butadiene-styrene terpolymer (ABS) and a blend of ABS and a polycarbonate.

The terms “plateable” and “non-plateable” are made with reference to the particular electroplating chemistry, material pretreatment, and conditions utilized prior to and during the electroplating process. Polycarbonate and polymethylmethacrylate are typically non-plateable using conventional electroless plating processes and conventional electroplating processes. However the surfaces of polycarbonate and/or polymethylmethacrylate components may be modified and/or the electroplating chemistry may be modified so as to cause plating of a metal onto polymethylmethacrylate and/or polycarbonate. Under such conditions, the polycarbonate and/or polymethylmethacrylate are no longer non-plateable. Similarly, while ABS and/or alloys of ABS/polycarbonate are normally plateable, it may be possible to modify the plating chemistry so as to prevent plating of such materials. Thus the expressions “plateable” and “non-plateable” as used in this specification, including the appending claims, is to be interpreted relative to the electroplating processes used in the claimed methods and assemblies. Thus, the use of two different plastic materials, both of which are plateable under different conditions, is encompassed by the invention, provided that the electroplating conditions are selected such that only one of the two plastic materials is plated.

Typically, the metal plating process includes a step of electroplating a metal sublayer over the electroless plated metal before electroplating a decorative finish electroplate layer. In accordance with an aspect of this invention, an interesting decorative effect may be achieved by selectively etching the decorative finish electroplate in a desired pattern to expose portions of an underlying sublayer (e.g., nickel, copper, brass, bronze).

Various decorative patterns, textual matter, logos, etc. may be painted and/or printed onto the plated component. The plated component may also be provided with a polymer coating that may be clear, tinted, or pigmented, as desired to provide a decorative and/or protective coating. Tinted coatings are those containing liquid coloring agents that are miscible and/or soluble in the polymer, while pigmented coatings are those containing solid, particle coloring agents. Preferred techniques for printing and/or coating a polymeric material onto the metal plated surface of the plastic component are described in U.S. patent application Ser. No. 09/707,866, entitled “METHOD AND COMPOSITION FOR METALLIC FINISHES,” which is incorporated herein by reference in its entirety. In order to promote better adhesion between the metal plating and a subsequently applied polymer print or coating, it may be desirable to prepare the metal plating in accordance with the teachings of U.S. patent application Ser. No. 10/140,230, entitled “PROCESS FOR PREPARING CHROME SURFACE FOR COATING,” which is hereby incorporated herein by reference in its entirety.

In accordance with another aspect of the invention, a polymer coating may be applied to the metal plated component and subsequently etched to reveal a desired pattern of the underlying finish electroplate. Although other techniques may be used, laser etching is preferably used to precisely produce a desired pattern. Further, laser etching may be used to precisely control the depth of the etching. In this manner, it is possible to use laser etching to remove only the polymer coating to reveal the underlying finish electroplate and/or to remove both the polymer coating and a portion of the finish plate to particularly expose an underlying sublayer material (e.g., copper and/or nickel plate). In this manner, laser etching may be used to etch at least two patterns at different depths to produce unique decorative effects.

While the concepts and processes of the invention may be utilized for preparing various assemblies having a transparent plastic member (e.g., a window or lens, such as a magnifying lens) physically trapped in a metal plated component, the invention will be described in greater detail with respect to a pivoted flip cover component of a flip-style cell phone. Other potential applications for the invention have been mentioned above in the Background discussion, and will be apparent to the skilled artisan.

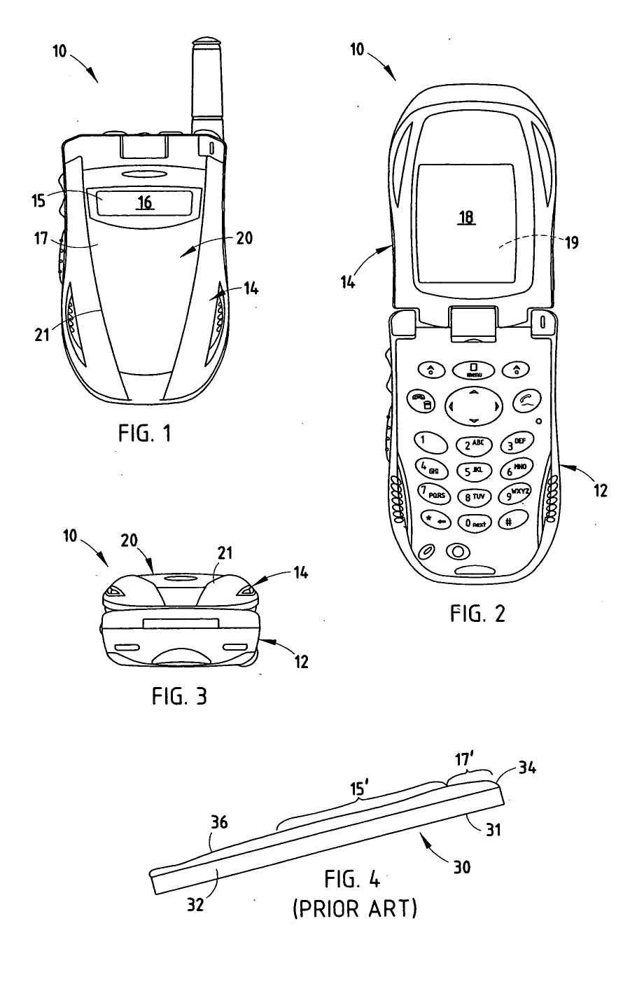

In the construction of flip-style cell phones, such as shown in FIGS. 1-3, a cell phone 10 includes a body 12 which is typically enclosed by a pivoted flip cover 14. On its outer surface, cover 14 includes a lens cover 20 with a transparent lens 15 with a line display screen 16 behind the lens. The lens 20 cover includes a decorative bezel 17 surrounding the lens 15. On the inside surface of the flip cover 14, there is provided a window 18 which allows the user to view a second full color LCD display 19 behind the window.

As shown in the prior art of FIG. 4, prior art lens covers 30 for the outer surface of the phone cover are typically molded from a layer of clear acrylic or polycarbonate 32 over which a graphic film layer 34 is applied, which incorporates a clear section over the lens area 15′ and graphic elements for the bezel area 17′. Additionally, lens covers 30 of the prior art may include a hard layer 36 providing scratch resistance to lens cover 30 and UV protection for the underlying line display. The undersurface 31 of the lens cover 30 may include rib structures which can accommodate assembly or other components incorporated in the cover 14 for the flip phone 10. Typically, a lens cover 20 of the present invention will be of three-dimensional shape conforming to the outer recessed surface of flip cover 14 and includes, as best seen in FIG. 1, a border 21 extending around the periphery thereof and conforming to the outer shape of a recess in the cover 14 of cell phone 10.

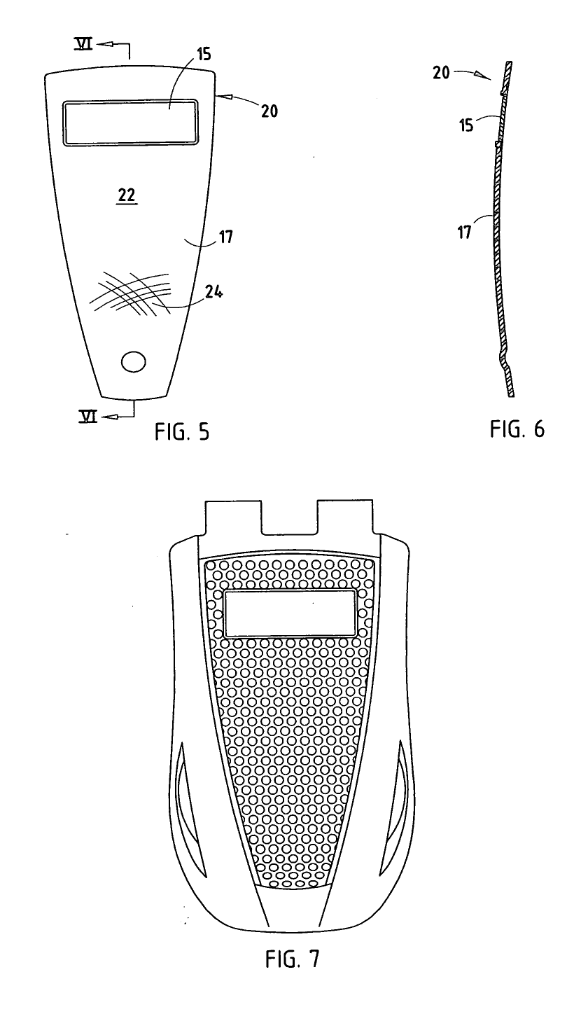

Referring to FIGS. 5 and 6, there is shown a lens cover 20 embodying the present invention, which includes a central clear polycarbonate lens 15 having a thickness of from about 1 mm to 2 mm and which defines the central lens area overlying the display 16 of the phone, as shown in FIG. 1. Surrounding the lens is a bezel 17 which can be molded along with lens 15 during a two-shot molding process, utilizing a plateable polymeric material for the bezel. Examples of plateable polymeric materials that may be used include, ABS, a blend of alloy of polycarbonate and ABS, or such a blend or alloy commercially available as Hipp-140™ from Lacks Enterprises Inc.

Instead of two-shot molding the lens 15 and bezel 17, lens 15 can be first molded and subsequently the bezel 17 insert-molded around the lens 15. Either process results in an integrated lens cover assembly shaped to conform to the recessed area of cover 14 of the flip phone. The plateable surface 22 (FIG. 5) of bezel 17 receives a metallic film plating 24 utilizing a plating process, such as described in U.S. Pat. No. 6,468,672. In practice, the plating of the bezel 17 integrates with the edges of the lens 15 so as not to provide a noticeable interface.

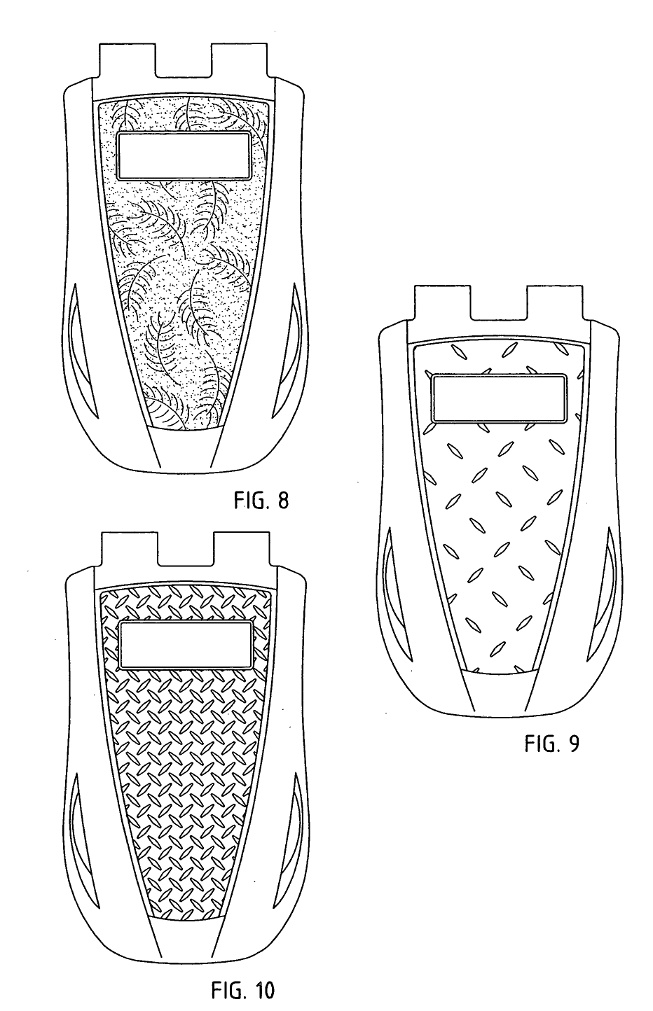

Once lens 15 is manufactured and the bezel plated with a metallic plating (such as chrome), which can be subsequently coated with a polymer composition that may be tinted to provide different metallic finishes or colors as desired, the external surface of plating 24 can be laser etched to provide printed indicia or graphics for the bezel, such as the manufacturer's name and logo or other graphic elements as desired using a finish as described in U.S. patent application Ser. No. 09/707,866, filed on Nov. 6, 2000, and entitled METHOD AND COMPOSITION FOR METALLIC FINISHES, the disclosure of which is incorporated herein by reference. As seen in FIGS. 7-11, the surface 22 of bezel 17 can be textured when molded with, for example, a pebble grain, as shown in FIG. 7, or other textures, as seen in FIGS. 9 and 10. Also, the plated surface 24 can contain laser etched graphic elements, such as 25 shown in FIG. 8. Further, the bezel can be pad printed or spray printed for other decorative accents. The entire outer exposed surface of the lens cover 20 can be sprayed with a hard coat and/or ultra violet (UV) inhibiting coating.

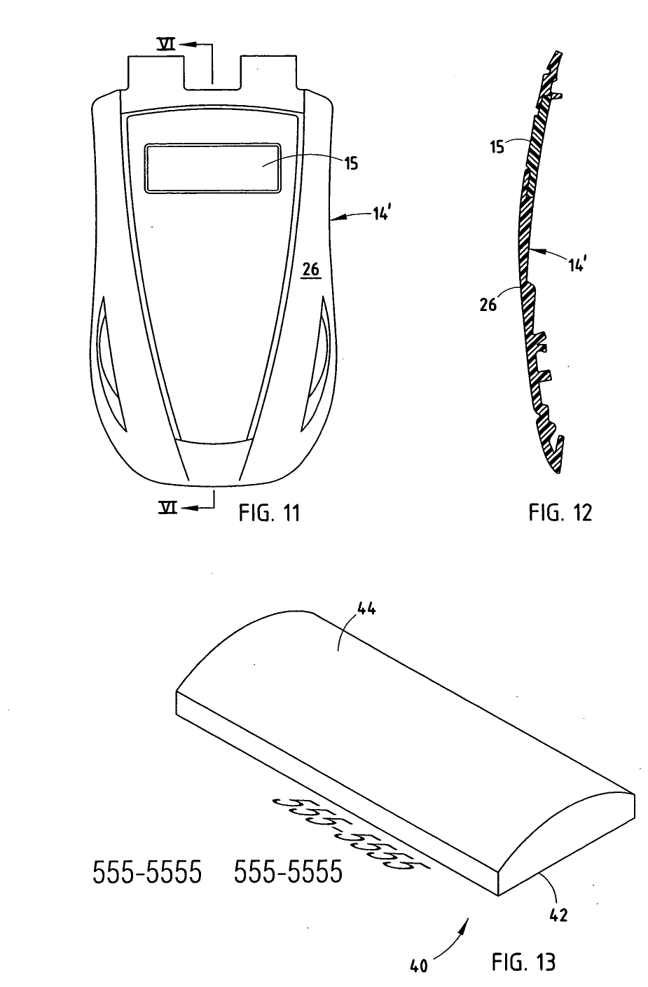

In some embodiments, it may be desirable to not only mold the lens cover 20, shown in FIGS. 5-10, which would replace the prior art lens cover 30 shown in FIG. 4, but mold the entire outer surface of a cover 14′ for the flip phone, which would include the centrally located lens 15, as well as the surrounding periphery which forms the entire exposed outer surface 26 of cover 14′ (FIGS. 11 and 12). This could be achieved by integrally molding the bezel 17 and surrounding cover 14 of the same plateable polymeric material, such as ABS or a polycarbonate/ABS combination. To create a graphic distinction between the bezel surface 17 and the surrounding cover 14, texture can be applied to one or the other areas, preferably area 17. Additionally, area 17 can be selectively painted or coated with a finish, as described in the above-identified patent application, as desired for the desired appearance of the outer surface of the phone cover 14. The lens 15 can then be two-shot molded or insert-molded to the cover 14′.

In yet another embodiment of the invention, the flat lens 15, shown in FIG. 1, which is a clear polycarbonate window exposing a line LCD display 16, provides the user with a relatively small display which may not be easy to read. In place of the clear polycarbonate window 15, a semicylindrical plano-convex lens 40 (FIG. 13) is provided and can be insert molded or two-shot molded with the lens cover 20 or the phone cover 14′ in place of lens 15. Lens 40 has a flat surface 42 facing the outside of cover 14 or 14′ and a convex surface 44 facing the underlying LCD display. Lens 40 is elongated to occupy the lens area 15, shown in FIG. 1, to provide the user with an enhanced image of increased size which is more readily viewable, thus making it easier for the user to view the information displayed on the LCD 16 underlying the lens 40.

It will become apparent to those skilled in the art that various modifications to the preferred embodiment of the invention as described herein can be made. Such modifications may include using the same processes and techniques for other applications, including other sections of the flip-style phone, such as the inside of cover 14. Such modifications and applications are within the spirit and scope of the invention as defined by the appended claims.

The invention claimed is:

1. A cover for a cell phone comprising:
a transparent plastic lens shaped to cover a display of a cell phone;
a bezel surrounding said lens, said bezel molded of a plateable thermoplastic material, wherein said lens is physically trapped by and/or bonded to said bezel; and
a plating covering a surface of said bezel.

2. The cover as defined in claim 1 wherein said display is an LCD display.

3. The lens cover as defined in claim 1 wherein the plating is chrome.

4. The lens cover as defined in claim 1 wherein the exterior plating is etched to provide graphic accents.

5. The lens cover as defined in claim 1 wherein a polymer coating is disposed on the plating.

6. The lens cover as defined in claim 5 wherein the polymer coating is tinted and/or pigmented.

7. The lens cover as defined in claim 1 wherein the bezel has a textured surface.

8. A magnifying lens for viewing a line LCD display for a cell phone window comprising a plano-convex lens adapted to be mounted to the cover of a cell phone overlying a line LCD display.

9. The magnifying lens as defined in claim 8 wherein said plano-convex lens is elongated with a width greater than its height.

10. A process for making an assembly including a plastic component having a transparent plastic member, comprising:
molding a transparent plastic member of a non-plateable thermoplastic material;
molding a plastic component around and/or on the transparent plastic member so that the transparent plastic member is physically trapped by the plastic component and/or chemically/electrostatically bonded to the plastic component, the plastic component being molded of a plateable thermoplastic material; and
plating a metal onto the plastic component.

11. The process of claim 10, wherein the transparent plastic member is molded before the plateable plastic component is molded, then the plastic component is molded on and/or around the transparent plastic member so that the transparent member is physically trapped by the plastic component and/or chemically/electrostatically bonded to the plastic component.

12. The process of claim 10, wherein the transparent plastic member and plateable plastic component are molded together using a two-shot molding technique.

13. The process of claim 10, wherein the plateable thermoplastic material is an acrylonitrile-butadiene-styrene terpolymer.

14. The process of claim 10, wherein the plateable thermoplastic material is a blend or alloy of a polycarbonate and an acrylonitrile-butadiene-styrene terpolymer.

15. The process of claim 10, wherein the non-plateable thermoplastic material is a polycarbonate.

16. The process of claim 10, wherein the non-plateable thermoplastic material is a polymethylmethacrylate.

17. The process of claim 10, wherein plating a metal onto the plastic component includes electrolessly plating a metal onto the plastic component;
electroplating a sublayer of metal; and
electroplating a finish electroplate layer.

18. The process of claim 17, wherein the metal sublayer is selected from copper, nickel, brass, bronze or a combination thereof.

19. The process of claim 17, wherein the finish electroplate layer is selected from chrome, brass, bronze, black nickel, black chrome, gold, silver and tin.

20. The process of claim 16, further comprising etching the finish electroplate to selectively reveal the underlying sublayer.

21. The process of claim 10, further comprising applying a polymer coating composition to the metal plating.

22. The process of claim 21, wherein the polymer coating is a clear coating.

23. The process of claim 21, wherein the polymer coating is tinted.

24. The process of claim 21, wherein the polymer coating is pigmented.

25. The process of claim 21, further comprising etching the polymer coating to selectively reveal the underlying finish electroplate layer.

26. The process of claim 17, further comprising applying a polymer coating to the finish electroplate layer.

27. The process of claim 26, further comprising etching the polymer coating to selectively reveal the underlying electroplate layer.

28. An assembly including a plastic component having a transparent plastic member, comprising:
a transparent plastic member physically trapped by a plastic component, and/or chemically/electrostatically bonded to the plastic component, and a metal plating on the plastic component.

29. The assembly of claim 28, wherein the transparent plastic member is comprised of a polycarbonate.

30. The assembly of claim 28, wherein the transparent plastic member is comprised of a polymethylmethacrylate.

31. The assembly of claim 28, wherein the plastic component is comprised of an acrylonitrile-butadiene-styrene terpolymer.

32. The assembly of claim 28, wherein the plastic component is comprised of a blend or alloy of a polycarbonate and an acrylonitrile-butadiene-styrene terpolymer.

33. The assembly of claim 28, wherein the plating includes at least one metal sublayer and a finish electroplate layer.

34. The assembly of claim 33, wherein the metal sublayer is selected from copper, nickel, brass, bronze, or a combination thereof.

35. The assembly of claim 33, wherein the finish electroplate layer is selected from chrome, brass, bronze, black nickel, black chrome, gold, silver and tin.

36. The assembly of claim 33, wherein the underlying metal sublayer is partially exposed through the etched patterns in the finish electroplate layer.

37. The assembly of claim 28, further comprising a polymer coating disposed on the metal plating.

38. The assembly of claim 37, wherein the polymer coating is a clear coating.

39. The assembly of claim 37, wherein the polymer coating is tinted.

40. The assembly of claim 37, wherein the polymer coating is pigmented.

41. The assembly of claim 37, wherein the metal plating is partially exposed through etched patterns in the polymer coating.

42. A process for fabricating a component having a transparent member physically trapped by and/or chemically/electrostatically bonded to a plastic component, comprising:
molding a transparent member;
molding a component on or around the transparent member so that the transparent member is physically trapped by and/or bonded to the plastic component; and
selectively plating only the plastic component, whereby the transparent member remains transparent.
